(19) United States
(12) Patent Application Publication
(10) Pub. No.: US 2012/0129528 A1
(43) Pub. Date: May 24, 2012

(54) BASE STATION, MOBILE STATION, COMMUNICATION SYSTEM, AND COMMUNICATION METHOD

(75) Inventor: Takaharu KOBAYASHI, Kawasaki (JP)

(73) Assignee: FUJITSU LIMITED, Kawasaki-shi (JP)

(21) Appl. No.: 13/300,820

(22) Filed: Nov. 21, 2011

(30) Foreign Application Priority Data
Nov. 22, 2010 (JP) 2010-260133

(51) Int. Cl. H04W 36/00

(52) U.S. Cl. 455/436

(57) ABSTRACT

A base station includes a receiver which receives a piece of state information indicating whether or not a mobile station passes through a location on a fixed route, and a processor which performs processing which determines that the mobile station is moving on the fixed route when the received state information of the mobile station performing a handover to a cell formed by the base station indicates that the mobile station passes through a location on the fixed route.

### CROSS-REFERENCE TO RELATED APPLICATIONS

This application is based upon and claims the benefit of priority from the prior Japanese Patent Application No. 2010-260133 filed on Nov. 22, 2010, the entire contents of which are incorporated herein by reference.

### FIELD

Embodiments discussed herein relate to an operation of a mobile station and a control method relating to services provided by a base station.

### BACKGROUND

In a mobile communication system, switching an operation of a mobile station or a service to be provided to the mobile station according to a moving mode of the mobile station may be convenient. For example, the mobile station may move on a known fixed route. In this case, since the mobile station may predict a destination of the mobile station, a result of the prediction may be used to perform, for example, scheduling control and state control of the mobile station. A result of the prediction may be used to provide a service according to the destination of the mobile station.

In the mobile communication system, for example, Japanese Laid-open Patent Publication No. 2004-172920 proposes that a controller of a mobile terminal switches an operation mode to a specific space mode from a regular operation mode if a user receives a position control signal from a specific radio base station placed at a ticket gate in a station when the user takes a train.

Furthermore, there is a proposal of a mobile communication system for periodically reporting location information to a management server from a radio mobile terminal. The management servicer has a determining unit that determines whether or not the radio mobile terminal is in a moving unit, a switching unit that switches a communication mode of the radio mobile terminal according to a determination result from the determining unit, and an instructing unit that instructs handover to the radio mobile terminal based on operation information and location information of the moving unit.

As the method for determining whether or not the mobile station moves on the fixed route such as a rail, there is a method for determining whether or not a user takes the train depending on reception of a location control signal from the radio base station provided at the ticket gate. However, the user who passes the ticket gate does not always take a train immediately, so the method is not efficient enough to determine whether or not the mobile station moves on the fixed route.

As the method for determining whether or not the mobile station moves on the fixed route, there is a method for determining whether or not the mobile station is inside the train by using the location information that is periodically transmitted from the mobile station. In this case, the mobile station is desired to have a measuring unit, and radio resource is consumed to transmit the location information.

### SUMMARY

According to an aspect of the invention, a base station includes a receiver which receives a piece of state information indicating whether or not a mobile station passes through a location on a fixed route, and a processor which performs processing which determines that the mobile station is moving on the fixed route when the received state information of the mobile station performing a handover to a cell formed by the base station indicates that the mobile station passes through a location on the fixed route.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration diagram of a first example of a communication system;

FIG. 2 is an explanatory diagram of the first example of a location relation between a fixed route and a cell;

FIG. 3 is an explanatory diagram of a hardware configuration example of a UE;

FIG. 4 is a function block diagram of the UE;

FIG. 5 is an explanatory diagram of a hardware configuration example of a base station;

FIG. 6 is a function block diagram of the first example of the base station;

FIG. 7 is an explanatory diagram of the first example of processing inside a communication system;

FIG. 8 is an explanatory diagram of the first example of UE control processing;

FIG. 9 is a function block diagram of a second example of the base station;

FIG. 10 is an explanatory diagram of the first example of route information;

FIG. 11 is an explanatory diagram of the second example of the UE control processing;

FIG. 12 is an explanatory diagram of the second example of the route information;

FIG. 13 is an explanatory diagram of a third example of the UE control processing;

FIG. 14 is an explanatory diagram of the third example of the route information;

FIG. 15 is an explanatory diagram of a fourth example of the UE control processing;

FIG. 16 is an explanatory diagram of the fourth example of the route information;

FIG. 17 is an explanatory diagram of the second example of the processing inside the communication system;

FIG. 18 is an explanatory diagram of a fifth example of the UE control processing;

FIG. 19 is a configuration diagram of the second example of the communication system;

FIG. 20 is a functional block diagram of the third example of the base station;

FIG. 21 is an explanatory diagram of the third example of the processing inside the communication system;

FIG. 22 is a function block diagram of the fourth example of the base station;

FIG. 23 is an explanatory diagram of the fourth example of the processing inside the communication system;

FIG. 24 is an explanatory diagram of the second example of the location relation between the fixed route and the cell;

FIG. 25 is an explanatory diagram of a fifth example of the route information;

FIG. 26 is a configuration diagram of the third example of the communication system;

FIG. 27 is a function block diagram of the fifth example of the base station; and

FIG. 28 is an explanatory diagram of the fifth example of the processing inside the communication system.

### DESCRIPTION OF EMBODIMENTS

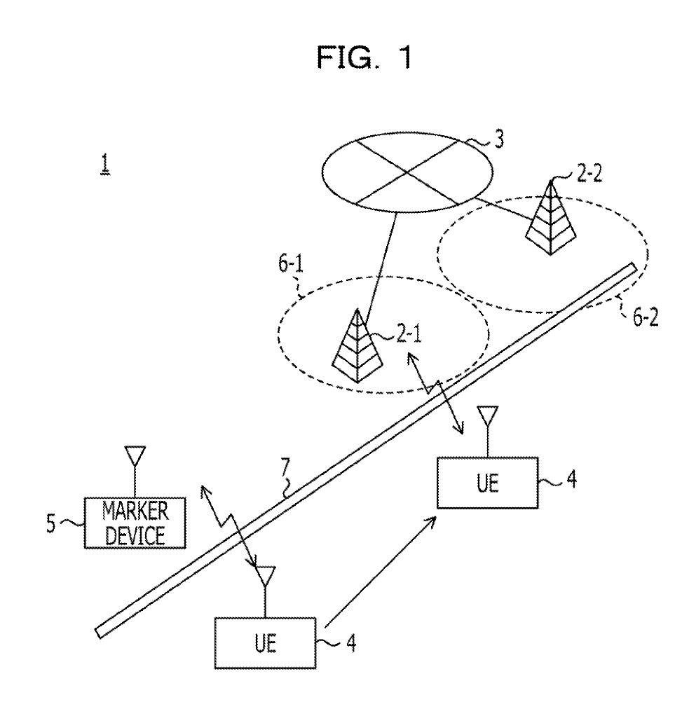

Embodiments of the present invention will be described below with reference to the attached diagrams. FIG. 1 is a configuration diagram of a first example of a communication system. A communication system 1 includes base stations 2-1 and 2-2, a communication network 3, a User Equipment (UE) 4 as a mobile station, and a marker device 5.

To perform data communication between the communication network 3 as a wired network and the UE 4, the base stations 2-1 and 2-2 perform radio communication with the UE 4. The base stations 2-1 and 2-2 form a cell 6-1 and a cell 6-2, respectively. The communication system 1 may include an upper node device, which couples each of the base stations 2-1 and 2-2 with the communication system 1, and a control device that controls the base stations 2-1 and 2-2. Hereinafter, the base stations 2-1 and 2-1 may be collectively referred to as “base station 2.” Furthermore, the cells 6-1 and 6-2 may be collectively referred to as “cell 6.”

A fixed route 7 is provided within the range of the cell 6. A fixed route indicates a prescribed moving path in which the UE 4 moves. The fixed route is, for example, a train line and a bus route. For example, the fixed route may be a transportation route in which a moving unit carrying a user is periodically operated.

The marker device 5 is provided on or near the fixed route 7 and transmits prescribed state control information. For example, the marker device 5 may be provided at a point or a gate through which the user having the UE 4 passes when the user starts or ends moving on the fixed route 7. For example, if the fixed route 7 is a train line, the marker device 5 may be provided at a ticket gate. The marker device 5 may be, for example, an automatic ticket gate. For example, if the fixed route 7 is a bus route, the marker device 5 may be provided at a bus stop.

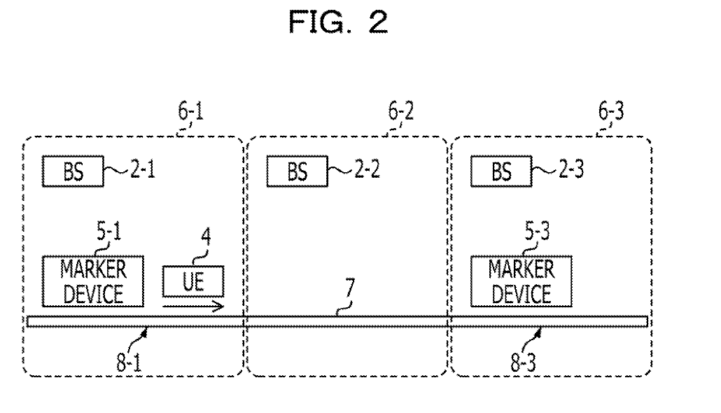

FIG. 2 is an explanatory diagram of a first example of a location relation between the fixed route 7 and the cell 6. Hereinafter, the base station 2 may be referred to as “BS,” and the user equipment may be referred to as “UE.” The cells 6-1 to 6-3 are formed by the base stations 2-1 to 2-3, respectively. The cell 6-1 is adjacent to the cell 6-2. The cell 6-2 is adjacent to the cell 6-3.

The fixed route 7 passes through the cells 6-1 to 6-3. A marker device 5-1 and a marker device 5-3 are provided at or near the points 8-1 and 8-3 on the fixed route 7. The points 8-1 and 8-3 are inside the cell 6-1 and the cell 6-3, respectively. For example, if the fixed route is a rail line, the points 8-1 and 8-3 may be the ticket gates in the station where the user gets on and gets off a train.

In the following description, there is an assumed case that the user having the UE 4 starts moving on the fixed route 7 at the point 8-1 and then ends moving on the fixed route 7 at the point 8-3 after passing through the cell 6-2. In the above-described scenario, for example, the user gets on a train at a station positioned at the point 8-1 and gets off the train at the station positioned at the point 8-3.

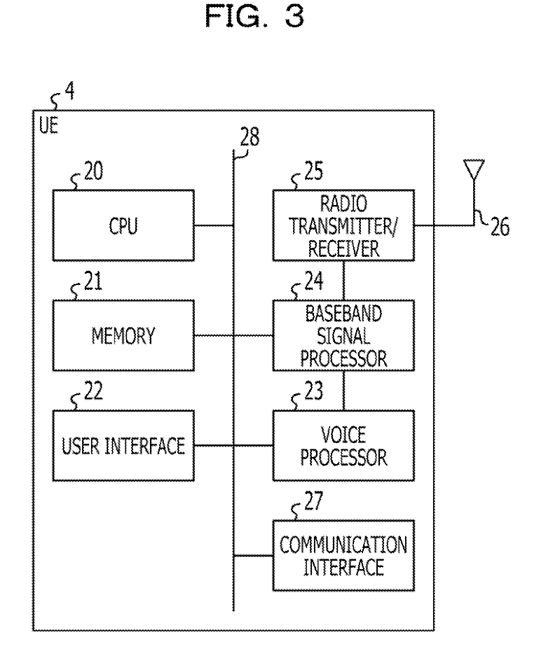

The UE 4 will be described below. FIG. 3 is an explanatory diagram of a hardware configuration example of the UE 4. The UE 4 includes a CPU 20, a memory 21, a user interface 22, a voice processor 23, a baseband signal processor 24, a radio transmitter/receiver 25, an antenna 26, and a communication interface 27. The CPU 20, the memory 21, the user interface 22, the voice processor 23, the baseband signal processor 24, and the communication interface 27 are coupled with each other with a bus 28. Hereinafter, the baseband may be referred to as “BB.”

The CPU 20 controls an operation of the UE 4 by executing a control program stored in the memory 21. The memory 21 stores data, which is desired by the CPU 20 to execute the control program, and temporal data that is generated when the control program is executed. The memory 21 includes, for example, a memory, a hard disk, or a nonvolatile memory.

The user interface 22 receives an input by the user into the UE 4 and outputs information. For example, the user interface 22 may be either one or more of a keypad, a keyboard, a cursor button, a scroll wheel, a touch panel, a microphone, a speaker, and a display.

The voice processor 23 converts a voice signal input from a microphone as the user interface 22 into a digital signal or converts voice data in a digital form handled by the UE 4 into a voice signal output from a speaker as the user interface 22.

Before and after performing modulation, the baseband signal processor 24 performs signal processing on a signal to be transmitted from or received by the radio transmitter/receiver 25. The radio transmitter/receiver 25 receives a radio signal to be transmitted to the UE 4 from the base station 2 through the antenna 26 and transmits the radio signal to be transmitted to the base station 2 from the UE 4 through the antenna 26.

The communication interface 27 receives the state control information transmitted from the marker device 5. For example, the communication interface 27 may perform short-distance radio communication, which is used for a non-contact IC card, with the marker device 5. For example, the reception of the state control information may be performed as ticket gate processing by an automatic ticket gate or as part of the ticket gate processing. The reception of the state control information and the ticket gate processing may be performed simultaneously or separately.

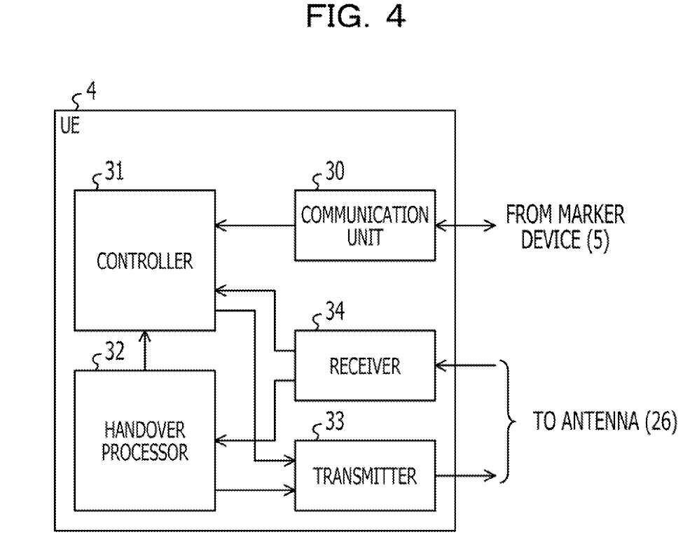

FIG. 4 is a function block diagram of the UE 4. FIG. 4 illustrates mainly a function related to the embodiment. The UE 4 includes a communication unit 30, a controller 31, a handover processor 32, a transmitter 33, and a receiver 34. The communication unit 30 receives the state control information transmitted from the marker device 5. The communication unit 30 and the receiver 34 may be the similar components. Each function of the controller 31 and the handover processor 32 is achieved by a processor such as a CPU.

When the UE 4 is in a first state, if the communication unit 30 receives the state control information, the controller 31 transfers a value of the state information that stores the state of the UE 4 to the second state from the first state. For example, the first state is a state in which the UE 4 is not moving on the fixed route. The second state is a state in which there is a possibility that the UE 4 moves on the fixed route or the UE 4 is moving on the fixed route.

Furthermore, if the state communication unit 30 receives the state control information while the UE 4 is in the second state, the controller 31 transfers the value of the state information of the UE 4 to the first state from the second state. In a prescribed period after the state is once transferred, the controller 31 may prohibit the following transfer in such a way that the state of the UE 4 is not transferred by the state control information transmitted from the marker device 5. Alternatively, the state control information may include an identifier of the marker device 5 to determine whether or not the state control information is transmitted from the marker device 5.

The handover processor 32 performs processing on the UE 4 when the UE 4 performs handover from a cell to another cell. When the handover processor 32 performs the handover processing, the transmitter 33 transmits the state information indicating either the UE 4 is in the first state or the second state. For example, the transmitter 33 may transmit the state information as additional information of handover request information in which the UE 4 requests the handover to the base station 2. The transmitter 33 may transmit the state information separately from the handover request information.

Furthermore, when the state of the UE 4 is transferred to the first state from the second state, the transmitter 33 transmits the state information to the base station 2 that is being coupled with the UE 4.

The receiver 34 receives, from the base station 2 coupled with the UE 4, the control information that controls the operation of the UE 4. The control information may be schedule information that specifies a radio resource allocated to the UE 4. For example, the control information may be information that specifies the communication method, the coding rate, and the communication rate.

The control information may include an operation state control signal that controls the operation state of the UE 4. The operation state control signal may be a signal that switches the operation mode of the UE 4 to a silent mode or an arbitrary operation mode that is specified by the user. The operation state control signal may be a control signal for switching on/off of the UE 4. The controller 31 controls the operation of the UE 4 according to the control information received by the receiver 34.

The receiver 34 receives the data transmitted from the base station 2 and provided as a service for a user of the UE 4. The date may include various types of information related to a region through which the fixed route 7 passes. The information may be, for example, store information, public services, and tourist information.

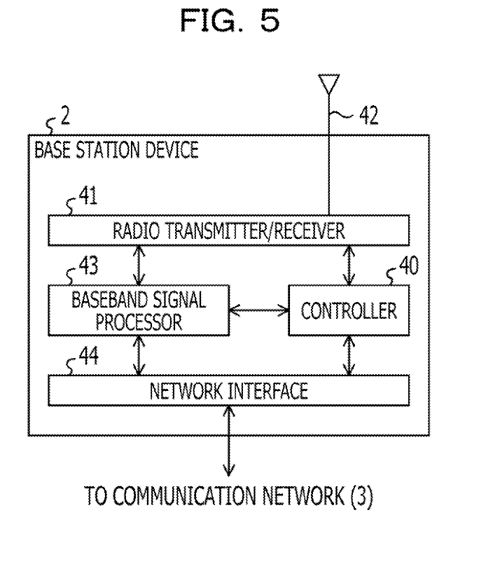

The base station 2 will be described below. FIG. 5 is an explanatory diagram of a hardware configuration example of the base station 2. The base station 2 includes a controller 40, a radio transmitter/receiver 41, an antenna 42, a baseband signal processor 43, and a network interface 44. The controller 40 controls the operation of the base station 2. The function of the controller 40 may be achieved by a processor such as a CPU.

The radio transmitter/receiver 41 transmits a radio signal to be transmitted to the UE 4 from the base station 2 through the antenna 42 and receives the radio signal to be transmitted to the base station 2 from the UE 4 through the antenna 42. Before and after modulating, the baseband signal processor 43 performs the signal processing on the signal to be transmitted from or received by the radio transmitter/receiver 41. The network interface 44 is allocated between the communication network and an upper node device used to couple the base station 2 with the communication system 1, a control device that controls the base station 2, or other base stations.

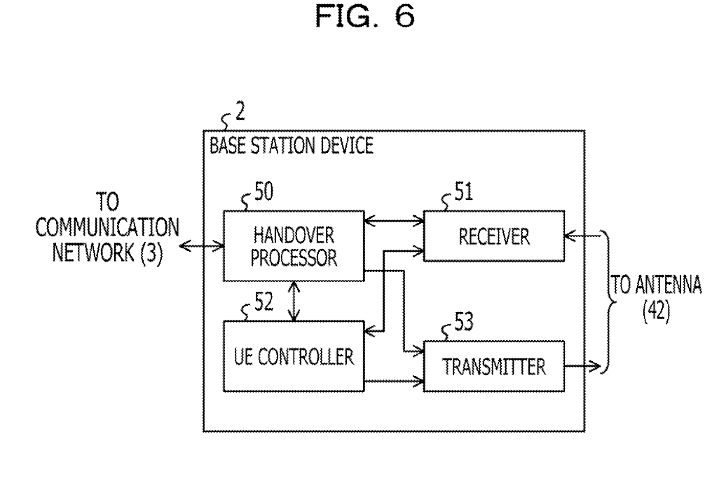

FIG. 6 is a function block diagram of a first example of the base station 2. FIG. 6 illustrates a function related to the present embodiment. The function block diagram of another example of the base station 2 described below has the similar configuration. The base station 2 includes a handover processor 50, a receiver 51, a UE controller 52, and a transmitter 53. The components of the present embodiment may be combined with the other embodiments described below. Each function of the handover processor 50 and the UE controller 52 may be achieved by a processor such as a CPU.

The handover processor 50 performs the handover processing for the UE 4 that enter the cell 6 formed by the base station 2 and for the UE 4 that exits from the cell 6 formed by the base station 2. The receiver 51 receives the state information to be transmitted from the UE 4 at the time of the handover.

The UE controller 52 determines whether the UE 4, which performs the handover to the cell 6 formed by the base station 2, is in the first state or the second state. If the UE 4 is in the second state, the UE controller 52 determines that the UE 4 is moving on the fixed route 7.

The UE controller 52 may generate the control information that controls the operation of the UE 4 according to a determination result. The transmitter 53 may transmit the control information generated by the UE controller 52 to the UE 4. According to the determination result, the UE controller 52 may control a radio resource, a communication method, a coding rate, a communication rate, and the like of the radio communication with the UE 4.

If the UE controller 52 determines that the UE 4 is moving on the fixed route 7, the base station 2 may transmit, to the UE 4, the data provided for a service for a user who is moving on the fixed route 7.

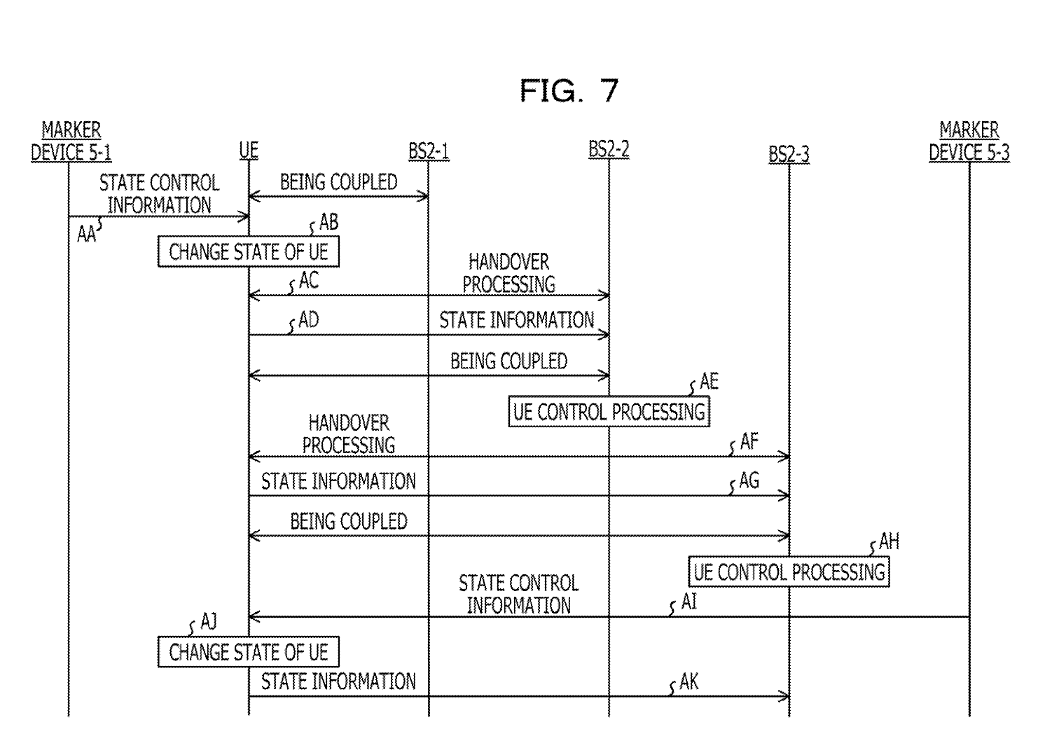

A processing procedure in the communication system 1 will be described below. FIG. 7 is an explanatory diagram of the first example of the processing in the communication system 1. According to other embodiments, each of the following Operations AA to AK may be an operation, process or step.

The UE 4 is positioned inside the cell 6-1 and is coupled with the base station 2-1. The UE 4 is in the first state. In Operation AA, if a user reaches the point 8-1 at which the marker device 5-1 is provided, the communication unit 30 receives the state control information transmitted from the marker device 5-1. In Operation AB, the controller 31 transfers the value of the state information that stores the state of the UE 4 to the second state from the first state.

After that, the UE 4 moves into the cell 6-2. In Operation AC, the handover processor 32 of the UE 4 and the handover processor 50 of the base station 2-2 perform processing in such a way that the UE 4 performs the handover to the cell 6-2 from the cell 6-1.

In Operation AD, the transmitter 33 of the UE 4 transmits the state information indicating that the UE 4 is in the second state to the base station 2-2. The receiver 51 of the base station 2-2 receives the state information. The UE 4 is coupled with the base station 2-2.

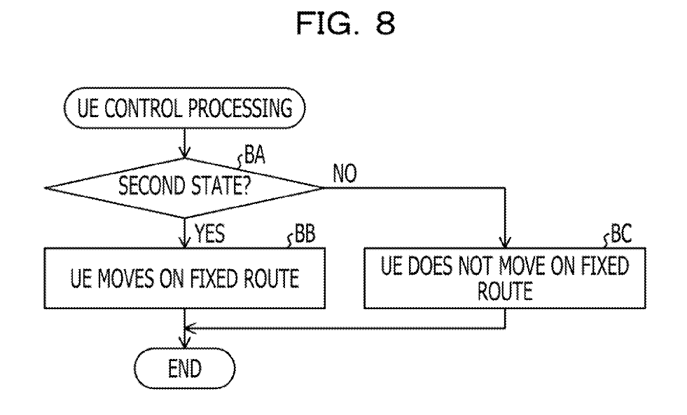

In Operation AE, the UE controller 52 of the base station 2-2 performs the UE control processing described below. FIG. 8 is an explanatory diagram of the first example of the UE control processing illustrated in FIG. 7. According to the other embodiments, each of the following Operations BA to BC may be an operation, process or step.

In Operation BA, the UE controller 52 determines whether or not the UE 4 is in the second state based on the received state information. If the UE 4 is in the second state (YES in Operation BA), the process goes to Operation BB. If the UE 4 is not in the second state (NO in Operation BB), the process goes to Operation BC.

In Operation BB, the UE controller 52 determines that the UE 4 is moving on the fixed route 7. In Operation BC, the UE controller 52 determines that the UE 4 is not moving on the fixed route 7.

After that, the UE controller 52 controls the operation of the UE 4 according to the determination result. If the UE controller 52 determines that the UE 4 is moving on the fixed route 7, the base station 2 may transmit, to the UE 4, the data provided for the service for the user who is moving on the fixed route 7.

With reference to FIG. 7, an embodiment will be described. The UE 4 moves into the cell 6-3. In Operation AF, the handover processor 32 of the UE 4 and the handover processor 50 of the base station 2-3 perform the processing in such a way that the UE 4 performs the handover to the cell 6-3 from the cell 6-2.

In Operation AG, the transmitter 33 of the UE 4 transmits the state information indicating that the UE 4 is in the second state to the base station 2-3. The receiver 51 of the base station 2-3 receives the state information. The UE 4 is coupled with the base station 2-3. In Operation AH, the UE controller 52 of the base station 2-3 performs the above-described UE control processing.

In Operation AI, if the user reaches the point 8-3 at which the marker device 5-3 is provided, the communication unit 30 receives the state control information transmitted from the marker device 5-3. In Operation AJ, the controller 31 transfers the value of the state information that stores the state of the UE 4 to the first state from the second state. In Operation AK, the transmitter 33 of the UE 4 transmits the state information indicating that the UE 4 is in the first state to the base station 2-3. The receiver 51 of the base station 2-3 receives the state information.

According to the present embodiment, the base station 2 may determine whether or not the UE 4 is moving on the fixed route. Therefore, the base station 2 may predict the destination of the UE 4, so that the prediction result may be used to perform, for example, scheduling control and state control of the UE 4. Furthermore, the prediction result may be used to provide a service according to the destination of the UE 4.

According to the present embodiment, the base station 2 determines that the UE 4 is moving on a known fixed route. This determination is made not simply by determining that the UE 4 passes near the marker device 5 but also by detecting that the UE 4 reaches another point on the fixed route 7, which is separated to some extent from the marker device 5, by the handover between the cells. This may improve determining accuracy for determining whether or not the UE 4 is moving on the fixed route.

According to the present embodiment, the UE 4 does not typically transmit the actual location to the base station 2. Therefore, the UE 4 that does not have a measuring unit may be used. The radio resource is not typically consumed to transmit the actual location.

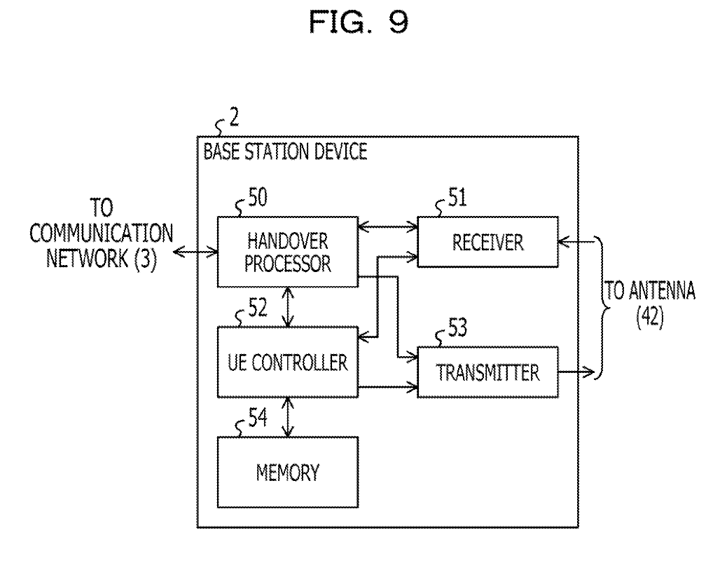

Another embodiment of the base station 2 will be described. FIG. 9 is a function block diagram of the second example of the base station 2. The base station 2 includes the components equivalent to the components of the other embodiment described above. The similar components are indicated with the similar reference numerals, so that the description of the similar function is omitted. The base station 2 includes a memory 54. The components of the present embodiment may be combined with the other embodiments described below.

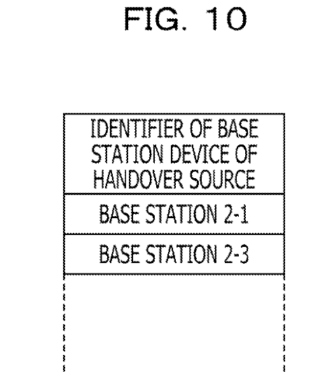

The memory 54 stores the route information. The route information includes information that specifies the base station of the handover source of the UE 4, which moves on the fixed route 7 and performs the handover to cell 6 formed by the base station 2. That is, the route information includes the information that specifies the base station that forms an adjacent cell of the cell 6, through which the fixed route 7 passes. FIG. 10 is an explanatory diagram of the first example of the route information stored in the memory 54.

The example of FIG. 10 illustrates the route information to be stored in the base station 2-2 if the cell is positioned as illustrated in FIG. 2. The route information stores the identifiers of the base stations 2-1 and 2-3 that form the adjacent cells 6-1 and 6-3 through which the fixed route 7 passes.

With reference to FIG. 9, the embodiment will be described. The UE controller 52 determines whether or not the identifier of the base station at the handover source of the UE 4 is included in the route information stored in the memory 54. The information that identifies the base station at the handover source of the UE 4 may be received by the handover processor 50 from the base station of the handover source or the upper control device through the communication network 3 or may be received directly from the UE 4.

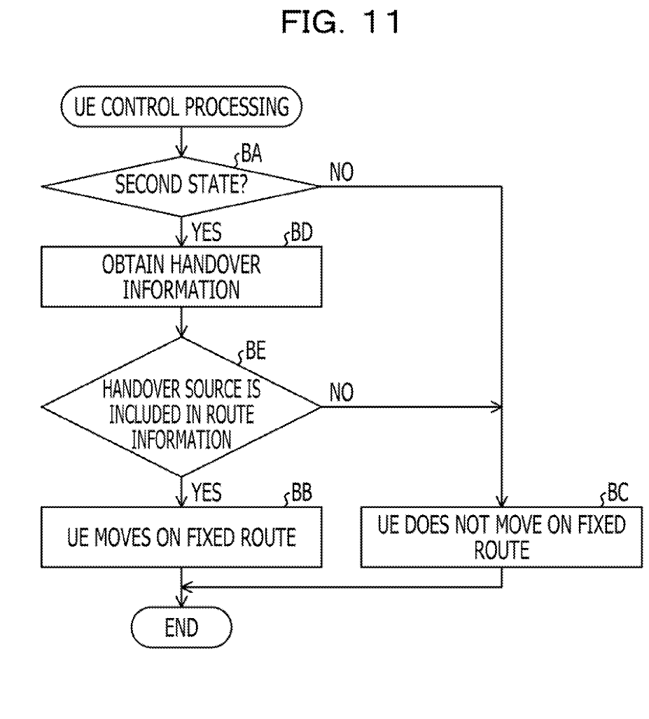

FIG. 11 is an explanatory diagram of the UE control processing using the route information. According to other embodiments, each of Operations BA to BE may be an operation, process or step. The processing illustrated in FIG. 11 is obtained by adding Operations BD and BE to the processing described with reference to FIG. 8. The processing in a case where the UE 4 performs the handover to the cell 6-2 will be described below.

In Operation BA, if the UE 4 is in the second state (YES in Operation BA), the process goes to Operation BD. If the UE 4 is not in the second state (NO in Operation BB), the process goes to Operation BC.

In Operation BD, the UE controller 52 obtains the information that identifies the base station of the handover source of the UE 4.

In Operation BE, the UE controller 52 determines whether or not the identifier of the base station 2-1 of the handover source of the UE 4 is included in the route information stored in the memory 54. If the identifier of the base station 2-1 is included in the route information (YES in Operation BE), the process goes to Operation BB. If the identifier of the base station 2-1 is included in the route information (NO in Operation BE), the process goes to Operation BC.

According to the present embodiment, the UE controller 52 determines not simply whether or not the UE 4 in the second state performs the handover but also whether or not the UE 4 performs the handover from the adjacent cell 6 through which the fixed route 7 passes. Therefore, according to the present embodiment, if the UE 4 that performs the handover is in the second state due to an unexpected matter even though the UE 4 does not start moving on the fixed route 7, erroneous determination indicating that the UE 4 is moving on the fixed route may be prevented.

Another embodiment of the base station 2 will be described below. If a moving unit carrying the UE 4 on the fixed route 7 periodically passes through the cell 6 and if the moving speed of the moving unit is fixed, the speed and the location of the UE 4 may be estimated depending on what time in a day the handover occurs. If the fixed route 7 is a train line, trains are operated at a fixed time and a fixed speed every day, so that the handover occurs regularly.

According to the present embodiment, the route information stored in the memory 54 includes speed information in which the scheduled occurrence time of the handover in a day corresponds to the scheduled speed of the UE 4 that performs the handover at each scheduled occurrence time. The components of the present embodiment may be combined with the other embodiments described below.

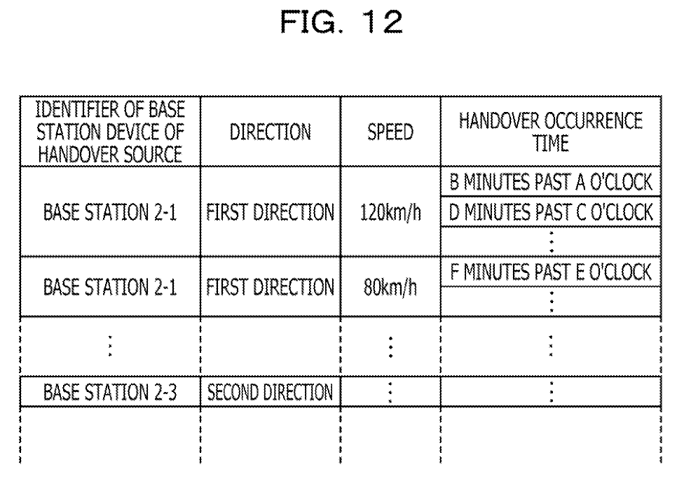

FIG. 12 is an explanatory diagram of an example of the route information that includes the speed information. The example illustrated in FIG. 12 illustrates an example of the route information stored in the base station 2-2 if the cell is allocated as illustrated in FIG. 2. The route information includes the moving direction information in which the base station of the handover source corresponds to the moving direction of the UE 4. The route information includes the speed information in which the scheduled handover occurrence time corresponds to the scheduled speed of the UE 4 that performs the handover at each scheduled occurrence time for each base station of the handover source.

For example, the scheduled speed of the UE 4, which is scheduled to perform the handover at B minutes past A o'clock and D minutes past C o'clock from the cell 6-1 formed by the base station 2-1, is 120 km/h, and the scheduled speed of the UE 4, which is scheduled to perform the handover at F minutes past E, is 80 km/h, and the moving speed of the UE 4 is a first direction. The moving direction of the UE 4 that performs the handover from the cell 6-3 formed by the base station 2-3 is the second direction as the opposite direction of the first direction. For example, if the fixed route 7 is a train line, the types of the first direction and the second direction may be “upbound” and “downbound.”

The UE controller 52 reads out the value of the moving direction from the moving direction information according to the identifier of the base station 2 of the handover source. According to the identifier of the base station 2 of the handover source of the UE 4 and to the handover occurrence time, the UE controller 52 reads out the value of the speed stored in accordance with the above-described information. By multiplying the read value of the speed by the elapse time from the handover occurrence time to the present time, the UE controller 52 determines a moving distance after the handover. The UE controller 52 estimates the point to a moving distance from the border point of the cell 6 in which the handover occurs in a reading direction along the fixed route 7.

The UE controller 52 may generate the control information that controls the operation of the UE 4 according to the estimated actual location. The transmitter 53 may transmit, to the UE 4, the control information generated according to the estimated actual location. The base station 2 may transmit, to the UE 4, the data provided for the service for user who is in the estimated actual location. For example, the service may be a voice guidance related to a view from the actual location of the UE 4. The service may be information providing service such as store information of stores near the actual location and public service and tourist service that is easily used from the actual location.

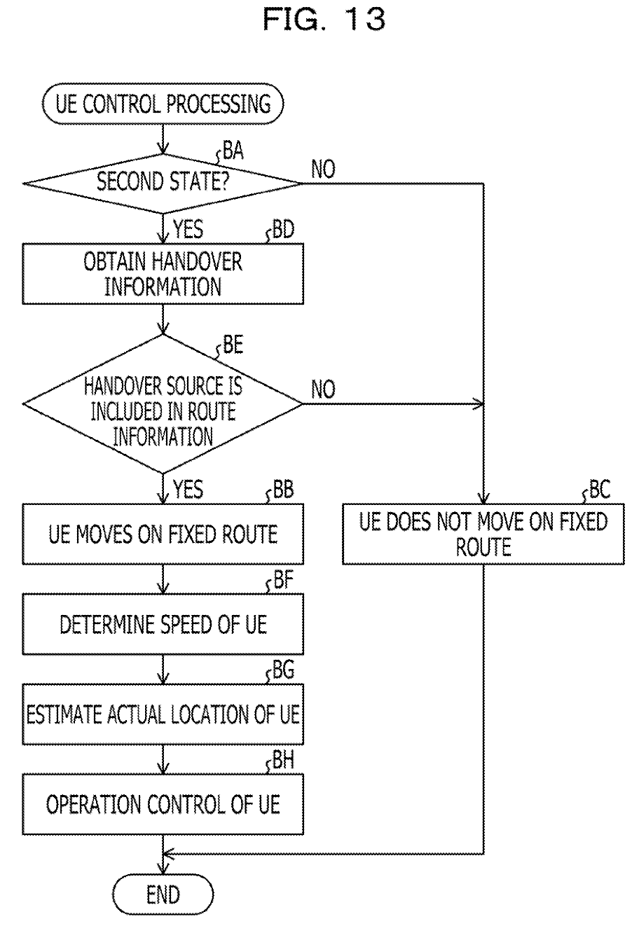

FIG. 13 is an explanatory diagram of UE control processing for estimating the actual location of the UE 4. According to the other embodiments, each of the following Operations BA to BH may be an operation, process or step. The processing illustrated in FIG. 13 is obtained by adding Operations BF to BH to the processing illustrated with the reference to FIG. 11.

When the UE 4 is moving on the fixed route 7, in Operation BF, according to the identifier of the base station 2 of the handover source and to the handover occurrence time, the UE controller 52 determines the speed of the UE 4 based on the speed information stored in the memory 54. According to the identifier of the base station 2 of the handover source, the UE controller 52 determines the moving direction of the UE 4 based on the moving direction information stored in the memory 54.

In Operation BG, the UE controller 52 determines a moving distance after the handover by multiplying the value of the determined speed by the elapse time from the handover occurrence time. The UE controller 52 estimates the actual location of the UE 4 based on the border point, the moving distance, and the moving direction within the cell 6 in which the handover occurs.

In Operation BH, the UE controller 52 generates the control information that controls the operation of the UE 4 according to the estimated actual location. The transmitter 53 transmits the control information, which is generated according to the estimated actual location, to the UE 4. The base station 2 may transmit the data, which is provided for the service for the user positioned in the estimated actual location, to the UE 4.

According to the present embodiment, the base station 2 may estimate the actual location of the UE 4 inside the cell 6. The base station 2 controls the operation of the UE 4 according to the actual location of the UE 4 and may provide the service according to the actual location of the UE 4.

Another embodiment of the base station 2 will be described. When the moving speed 4 of the UE 4 is determined, variation of the reception quality of the UE 4 according to the location of the UE 4 after the handover occurs may be predicted.

According to the present embodiment, the route information stored in the memory 54 includes quality information that specifies, for each moving speed, the reception quality of the UE 4 that is scheduled in each elapse time after the handover time. The components of the present embodiment may be combined with the other embodiments described below.

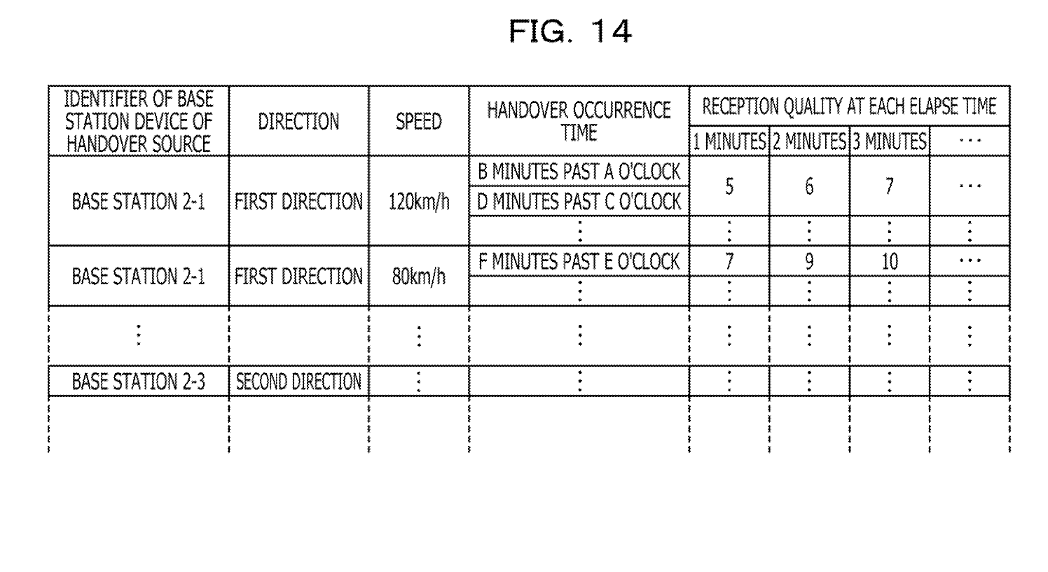

FIG. 14 is an explanatory diagram of an example of the route information that includes the quality information. As in FIG. 12, the example illustrated in FIG. 14 illustrates the route information stored in the base station 2-2 if the cell is allocated as illustrated in FIG. 2. The route information includes the moving direction information in which the base station of the handover source corresponds to the moving direction of the UE 4. The route information includes the speed information in which the handover occurrence time corresponds to the speed of the UE 4 in each base station of the handover source. Regarding each of the base stations 2 of the handover source, the route information includes the scheduled reception quality of the UE 4 in each elapse time after the handover time and includes the quality information specified for each moving speed.

For example, the reception quality of the UE 4, which performs the handover from the cell 6-1 formed by the base station 2-1 at 120 km/h, is scheduled to indicate the indexes “5,” “6,” and “7” when one, two, and three minutes passes from the handover occurrence time, respectively. When one, two, and three minutes passes from the handover occurrence time, the reception quality of the UE 4 that performs the handover at 80 km/h from the cell 6-1 is scheduled to indicate the indexes “7,” “9,” and “10,” respectively.

According to the speed determined based on the base station 2 of the handover source and the handover occurrence time and to the elapse time from the handover occurrence time, the UE controller 52 reads out the value of the reception quality stored in accordance with the information. Since the speed of the UE 4 is uniquely determined based on the handover occurrence, the UE controller 52 may read out the value of the reception quality according to the speed determined based on the base station 2 of the handover source and the handover occurrence time and to the elapse time from the handover occurrence time. The UE controller 52 estimates the value of the read reception quality as the reception quality of the UE 4.

Instead of using the quality information illustrated in FIG. 14, the reception quality of each location on the fixed route 7 may be stored in the memory 54, and the reception quality may be estimated according to the estimated actual location of the UE 4.

The UE controller 52 generates the control information that controls the operation of the UE 4 according to the estimated reception quality. The transmitter 53 may transmit the control information generated according to the estimated reception quality to the UE 4.

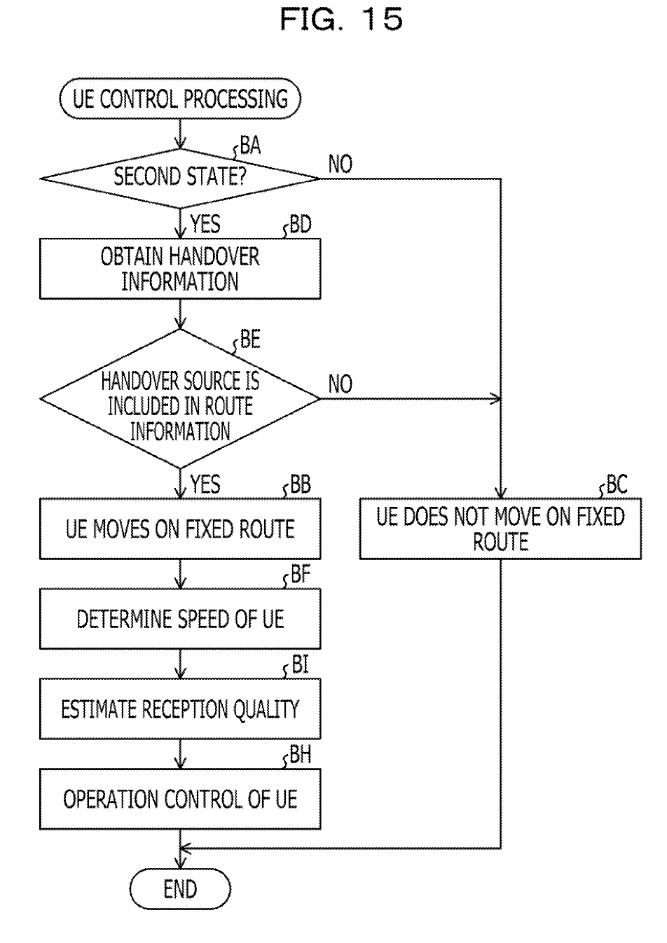

FIG. 15 is an explanatory diagram of the UE control processing for estimating the reception quality of the UE 4. According to the other embodiment, each of the following Operations BA to BI may be an operation, process or step. Operations BA to BF illustrated in FIG. 15 are equivalent to Operations BA to BF of the processing illustrated with reference to FIG. 13.

After Operation BF, the process goes to Operation BI. In Operation BI, the UE controller 52 estimates the reception quality of the UE 4 according to the speed determined based on the base station 2 of the handover source and the handover occurrence time and to the elapse time from the handover occurrence time. The process goes to Operation BH.

In Operation BH, the UE controller 52 generates the control information that controls the operation of the UE 4 according to the estimated reception quality. The transmitter 53 transmits the control information generated according to the estimated reception quality to the UE 4.

According to the present embodiment, the base station 2 may estimate the reception quality of the UE 4 inside the cell 6. Therefore, the base station 2 may control the operation of the UE 4 according to the reception quality of the UE 4.

Another embodiment of the base station 2 will be described. Since a part-length of the fixed route 7 included in the cell 6 has a fixed value, the duration time in which the UE 4 with each speed is continuously coupled with the base station 2 may be predicted if the moving speed 4 of the UE 4 may be determined.

Accordingly, by comparing the actual continuous coupling time of the UE 4 and the base station 2 to the scheduled continuous coupling time, the base station 2 may determine whether or not the UE 4 is actually moving on the fixed route. Alternatively, by comparing the actual continuous coupling time to the scheduled continuous coupling time, the base station 2 may determine whether or not the UE 4 is moving at a scheduled speed.

According to the present embodiment, the route information stored in the memory 54 includes the coupling time information that specifies the average coupling time, in which the UE 4 moving on the fixed route at each moving speed is continuously coupled with the base station 2, for each of the base stations 2 of the handover source. In this case, the average coupling time indicates the average of the coupling time in which the UE 4 moving on the fixed route 7 is continuously coupled with the base station 2. The components of the present embodiment may be combined with the other embodiments described below.

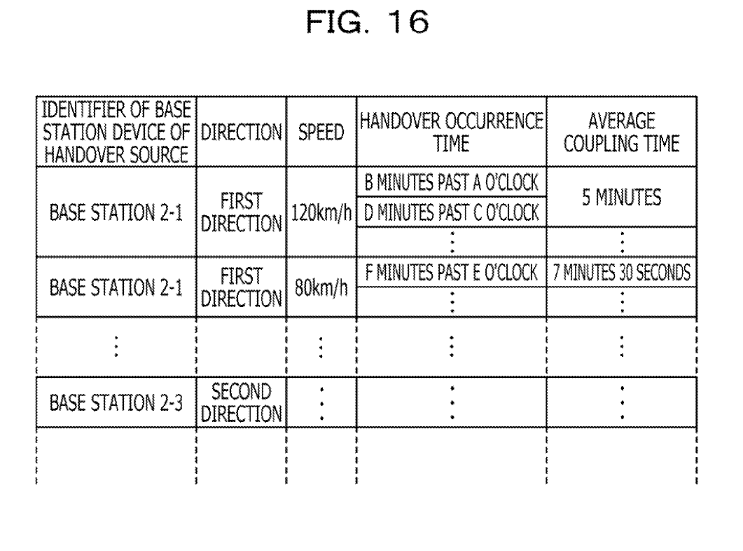

FIG. 16 is an explanatory diagram of the route information that includes the coupling time information. As in FIG. 12, the example illustrated in FIG. 16 illustrates an example of the route information stored in the base station 2-2 when the cell is allocated as illustrated in FIG. 2. The route information includes the moving direction information in which the base station of the handover source corresponds to the moving direction of the UE 4. The route information includes the speed information in which the handover occurrence time corresponds to the speed of the UE 4 for each of the base stations of the handover source. The route information includes the coupling time information that specifies the average coupling time in which the UE 4 moving on the fixed route 7 at each moving speed is scheduled to be continuously coupled with the base station 2.

For example, the average coupling time of the UE 4, which performs the handover at 120 km/h from the cell 6-1 formed by the base station 2-1, is 5 minutes. The average coupling time of the UE 4, which performs the handover at 80 km/h from the cell 6-1, is 7 minutes 30 seconds.

According to the speed determined based on the base station 2 of the handover source and the handover occurrence time, the UE controller 52 reads out the value of the average coupling time stored in accordance with the base station 2 of the handover source and the speed. Since the speed of the UE 4 is uniquely determined from the handover occurrence time, the UE controller 52 may read out the value of the average coupling time according to the speed determined based on the base station 2 of the handover source and the handover occurrence time and to the elapse time from the handover occurrence time. The UE controller 52 determines whether or not the actual continuous coupling time of the UE 4 is longer than the average coupling time. Instead, the UE controller 52 determines whether or not the actual continuous coupling time of the UE 4 is longer than the value obtained by adding a prescribed margin to the average coupling time.

If the actual continuous coupling time is longer than the average coupling time, the UE controller 52 determines whether or not the UE 4 is deviating from the fixed route 7 or the UE 4 is not moving at the scheduled speed. At this time, the UE controller 52 transmits a state change signal, which transfers the state of the UE 4 to the first state, to the transmitter 53.

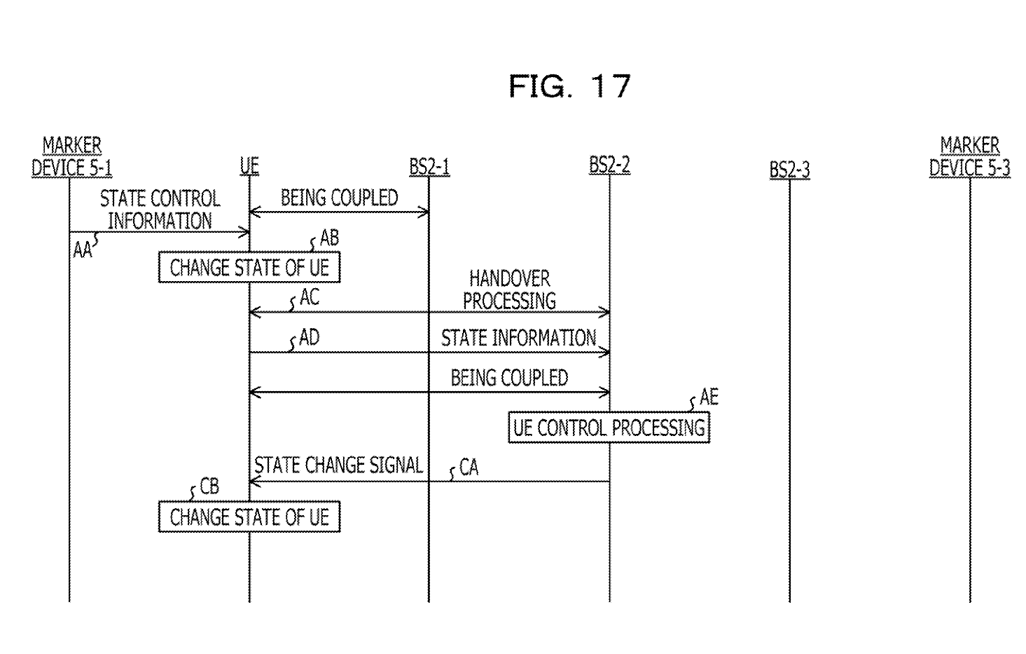

FIG. 17 is an explanatory diagram of the processing inside the communication system 1 in a case of using the coupling time information. According to the other embodiments, each of the following Operations AA to AE, CA, and CB may be an operation, process or step. Operations AA to AD illustrated in FIG. 15 are equivalent to Operations AA to AD of the processing illustrated with reference to FIG. 7.

In Operation AE, the UE controller 52 of the base station 2-2 performs the UE control processing described below.

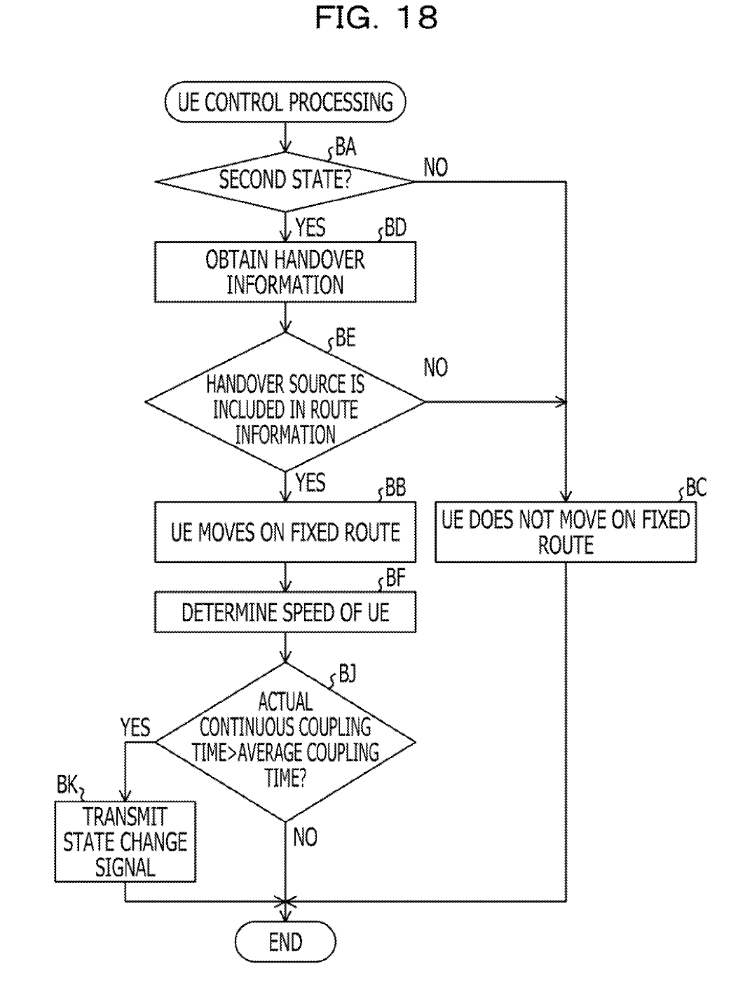

FIG. 18 is an explanatory diagram of the UE control processing in a case of using the coupling time information. According to the other embodiments, each of the following Operations BA to BF, BJ, and BK may be an operation, process or step. Operations BA to BF illustrated in FIG. 18 are equivalent to Operations BA to BF of the processing illustrated with reference to FIG. 13.

After Operation BF, the process goes to Operation BJ. In Operation BJ, according to the base station 2 of the handover source and the speed, the UE controller 52 determines the average coupling time in which the UE 4 is continuously coupled to the base station 2. The UE controller 52 compares the average coupling time to the actual continuous coupling time of the UE 4.

The actual continuous coupling time exceeds the average coupling time (Y in Operation BJ), the process goes to Operation BK. If the actual continuous coupling time is not longer than the average coupling time (N in Operation BJ), the UE control processing ends.

In Operation BK, the UE controller 52 transmits the state change signal, which transfers the state of the UE 4 to the first state, to the transmitter 53.

With reference to FIG. 17, an embodiment will be described. The state change signal transmitted in Operation BK is received by the receiver 34 of the UE 4 in Operation CA. If the state change signal is received, the controller 31 of the UE 4 in Operation CB transfers the value of the state information of the state of the UE 4 to the first state from the second state.

In Operation BJ, if the actual continuous coupling time is not longer than the average coupling time, the UE 4 may perform the handover to the cell 6-3 after the UE control processing in Operation AE.

According to the present embodiment, the UE 4 that is once determined to be moving on the fixed route 7 may be determined to be deviating from the fixed route 7. For example, the operation of public transportation that the user of the UE 4 takes is not on schedule, so that the actual location and the reception quality may not be predicted. Therefore, according to the present embodiment, for example, the base station 2 prevents the user of the UE 4 from controlling the UE 4 and providing the service based on false assumption that the UE 4 is moving on the fixed route 7.

According to the actual location of the UE 4 estimated by the base station 2, the configuration of the communication system, in which the data to be provided for the service for the user who is in the estimated actual location, will be described below.

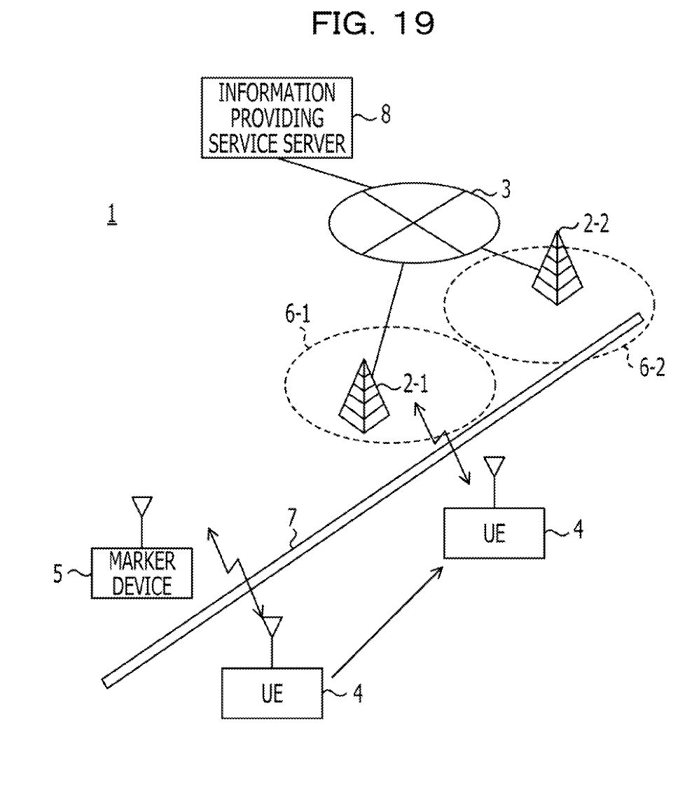

FIG. 19 is a configuration diagram of the second example of the communication system 1. The communication system 1 includes the components equivalent to the components of the communication system 1 illustrated in FIG. 1. The components equivalent to the components illustrated in FIG. 1 are indicated with the similar reference numerals, so that the similar description is omitted.

The communication system 1 includes the information providing service server 8 that is coupled with the communication network 3. The information providing service server 8 responds to a request from the base station 2 and provides the base station 2 with the data to be provided for the service for the user of the UE 4. The component of the present embodiment may be combined with the other embodiments described below.

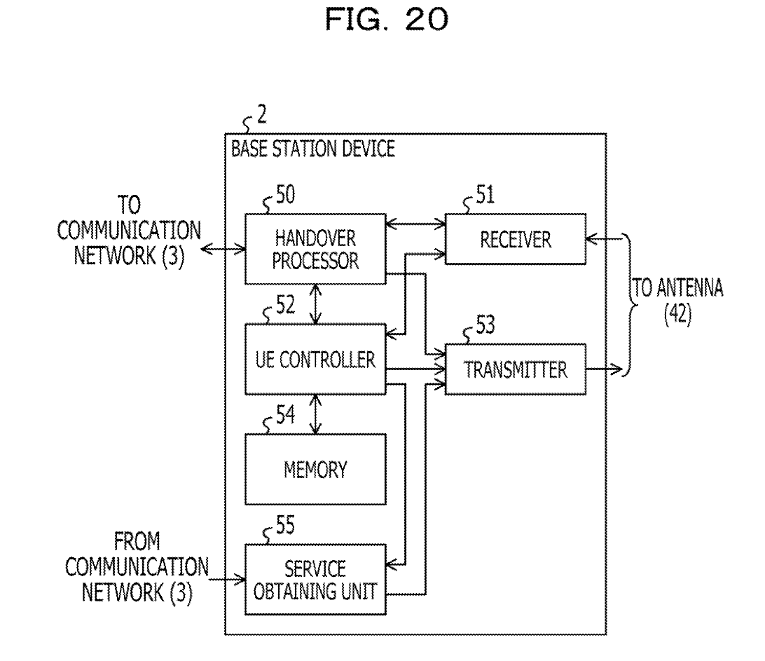

FIG. 20 is a function block diagram of the base station 2 used in the communication system 1 illustrated in FIG. 19. The base station 2 includes the components equivalent to the components of the other embodiments described above. The components equivalent to the components illustrated in FIG. 1 are indicated with the similar reference numerals, so that the similar description is omitted. The components of the present embodiment may be combined with the other embodiments.

The base station 2 includes a service obtaining unit 55. As described above, the UE controller 52 estimates the actual location of the UE 4. The service obtaining unit 55 requests the information providing service server 8 to transmit a service to be provided to the UE 4 that is positioned at the actual location estimated by the UE controller 52.

According to the request from the service obtaining unit 55, the information providing service server 8 transmits, to the service obtaining unit 55, the data for the service registered in advance to be provided to the UE 4 in the estimated actual location. The service obtaining unit 55 transmits the data, which is received from the information providing service server 8, to the UE 4 through the transmitter 53.

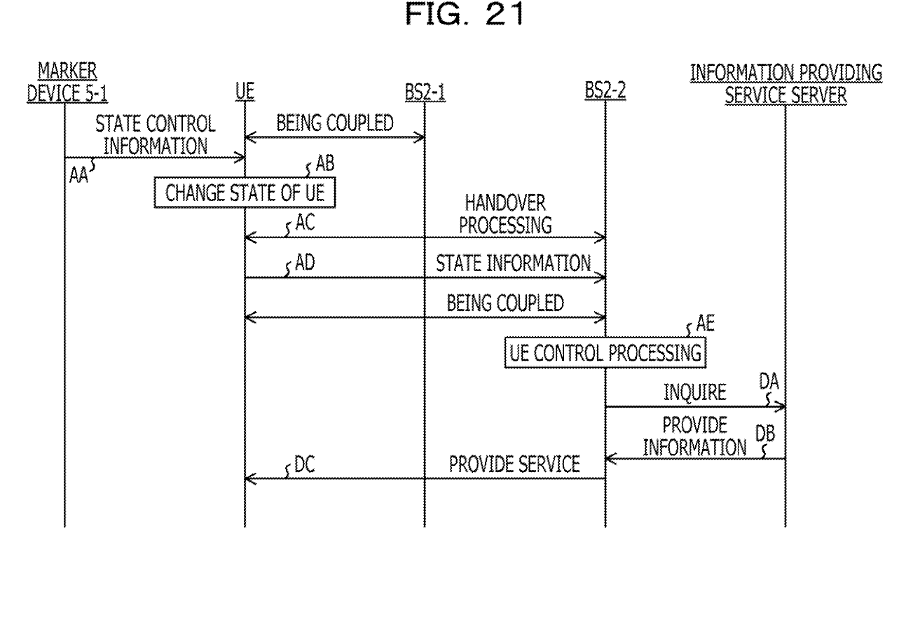

FIG. 21 is an explanatory diagram of a third example of the processing inside the communication system 1 that includes the information providing service server 8. According to the other embodiments, each of the following Operations AA to AE and Operations DA and DC may be an operation, process or step. Operations AA to AE illustrated in FIG. 21 are equivalent to Operations AA to AE of the processing illustrated in FIG. 7. In Operation AE, the UE controller 52 estimates the actual location of the UE 4.

In Operation DA, the service obtaining unit 55 makes an inquiry to the information providing service server 8 about the transmission of the service for the UE 4 positioned in the estimated actual location. In Operation DB, the information providing service server 8 transmits, to the service obtaining unit 55, the data of the estimated actual location for the service provided to the UE 4. In Operation DC, the service obtaining unit 55 transmits the data received from the information providing service server 8 to the UE 4.

According to the present embodiment, the base station 2 may provide the service according to the estimated actual location of the UE 4.

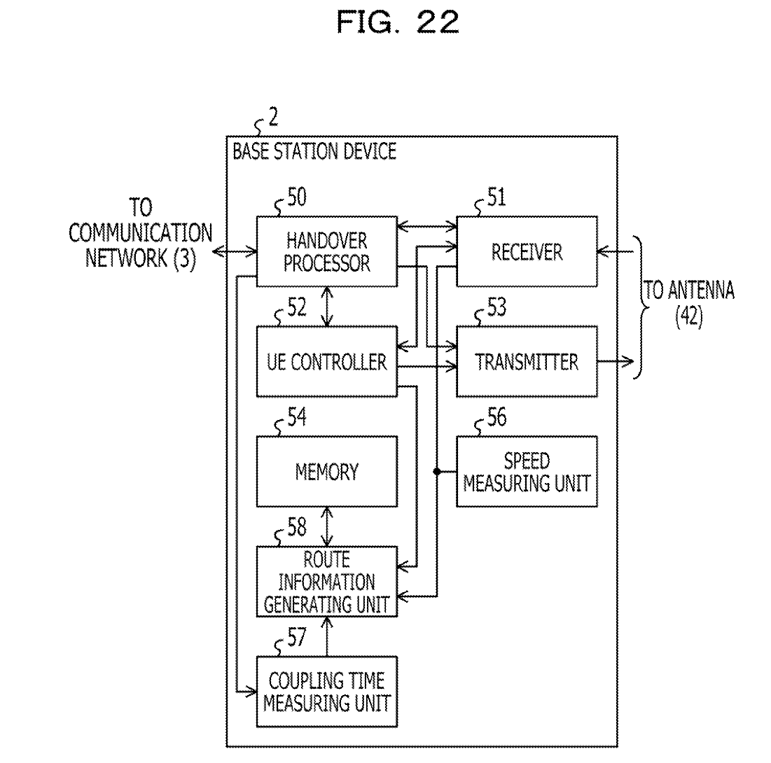

An example of a determining method for determining the speed information, the quality information, and the coupling time information stored in the route information will be described below. FIG. 22 is a function block diagram of a fourth example of the base station 2. The base station 2 includes the components equivalent to the components of the other embodiments described above. The similar components are indicated with the similar reference numerals, so that the description of the similar function is omitted. The components of the present embodiment may be combined with the other embodiments described below.

The base station 2 includes a speed measuring unit 56, a coupling time measuring unit 57, and a route information generating unit 58. According to the embodiment in which the coupling time information is not generated, the coupling time measuring unit 57 may be omitted.

The speed measuring unit 56 measures the speed of the UE 4 by performing Doppler frequency measurement of an uplink signal from the UE 4 that is in the second state, for example.

If the fixed route 7 is, for example, a public transportation such as a rail line, trains may be operated at a prescribed time and a prescribed speed every day, so that the time and the speed at which the handover occurs are regular.

By performing statistic processing for averaging the measurement value of the speed of the UE 4 that performs the handover at the same time on different days, the route information generating unit 58 estimates the moving speed of the UE 4 that performs the handover at each of the times. The route information generating unit 58 generates speed information by estimating each speed of the UE 4 at each handover occurrence time in each of the base stations devices of the handover source.

Actually, the occurrence of the handover that is expected to be made at the same time on different days may be changed because the transportation is not on schedule. Accordingly, the route information generating unit 58 generates frequency distribution of the handover occurrence time and determines that the handover that occurs during a prescribed period with the highest frequency time of occurrence is considered as the handover that occurs at the same time. Thus, the route information generating unit 58 may average the measurement value of the speed.

The coupling time measuring unit 57 measures the time in which the UE 4 is coupled to the base station 2 while the UE 4 in the second state performs the handover to the cell 6 and then performs the handover to another cell. By performing the statistic processing for averaging the coupling time measured several times on the UE 4 with each moving speed, the route information generating unit 58 estimates the coupling time for each moving speed. The route information generating unit 58 generates the coupling time information by estimating the coupling time for each moving speed for each of the base stations of the handover source.

The receiver 51 receives, from the UE 4 with each moving speed, the report of the reception quality measured at each time when each elapse time passes from the handover occurrence. By performing the statistic processing for averaging the reception quality that is reported several times for each moving speed and each elapse time, the route information generating unit 58 estimates the reception quality of the UE 4 with each moving speed for each elapse time from the handover. The route information generating unit 58 generates the quality information by estimating the reception quality for each base station of the handover source.

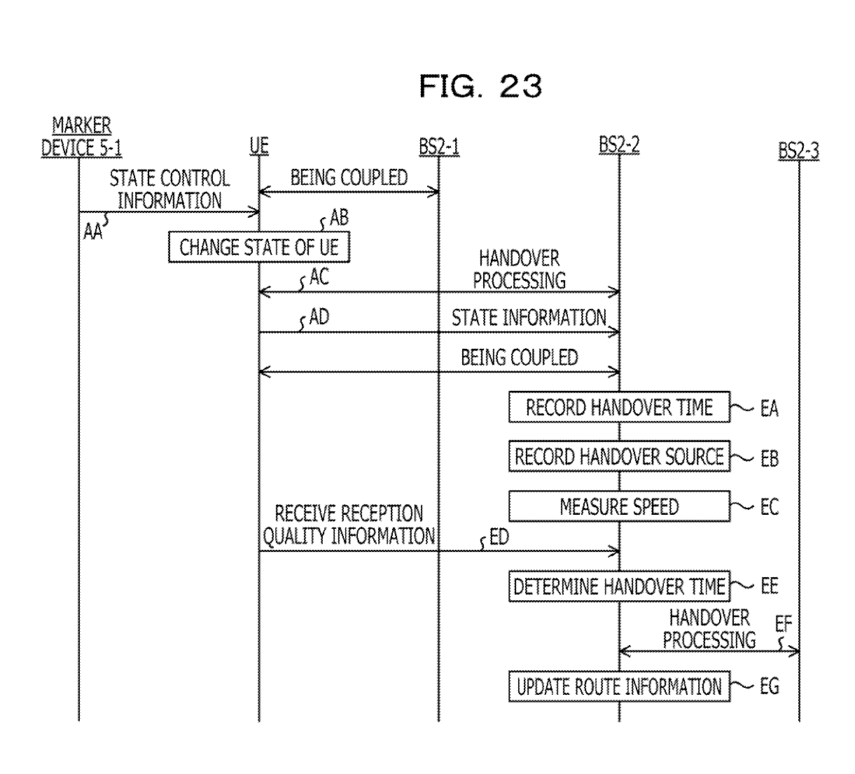

FIG. 23 is an explanatory diagram of the fourth example of the processing in the communication system 1. According to the other embodiments, each of the following Operations AA to AD and Operations EA to EG may be an operation, process or step. Operations AA to AD illustrated in FIG. 21 are equivalent to Operations AA to AD of the processing illustrated with reference to FIG. 7.

In Operation EA, the coupling time measuring unit 57 records the time at which the UE 4 performs the handover to the cell 6-2 formed by the base station 2-2. In Operation EB, the route information generating unit 58 records the base station 2-1 of the handover source of the UE 4.

In Operation EC, the speed measuring unit 56 measures the speed of the UE 4. In Operation ED, the receiver 51 receives the reception quality information that is sequentially transmitted from the UE 4.

When the UE 4 comes near the border between the cell 6-2 and the cell 6-3, the handover of the cell 6-3 of the UE 4 is started. In Operation EE, the coupling time measuring unit 57 determines the handover time of the UE 4 and measures the time in which the UE 4 is coupled with the base station 2. In Operation EF, the handover processing between the base station 2-2 and the base station 2-3 is performed.

In Operation EG, the route information generating unit 58 generates speed information, coupling time information, and quality information based on the identifier of the base station 2-1 of the handover source, the handover start time, the speed measurement value, the measurement value of the coupling time, and the reception quality reported from the UE 4. Based on the above-described generated information, the route information generating unit 58 updates the route information stored in the memory 54.

According to the present embodiment, speed information, coupling time information, and quality information may be generated based on the time at which the handover actually occurs, the measurement value of the moving speed of the UE 4, and the measurement value of the reception quality. For example, even if the schedule of the transportation operated on the fixed route 7 is changed, the speed information, the coupling time information, and the quality information may be generated.

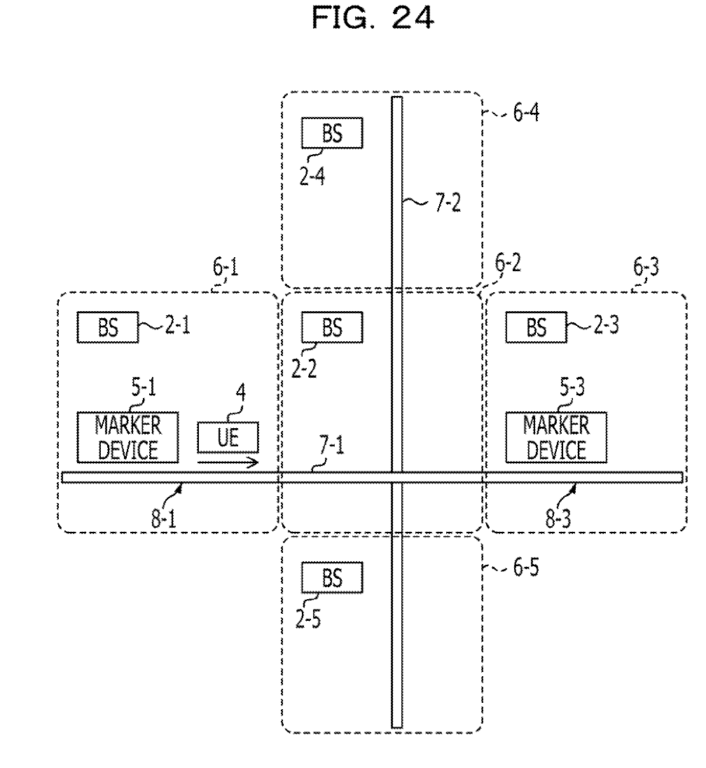

Processing to be performed when there is a plurality of fixed routes 7 will be described. FIG. 24 is an explanatory diagram of the second example of the location relation between the fixed route and the cell. The allocation example of the fixed route illustrated in FIG. 24 includes a fixed route 7-2 that passes through the cell 6-2 as well as a fixed route 7-1 corresponding to the fixed route 7 illustrated in FIG. 2. As illustrated in FIG. 24, the fixed route 7-2 passes through the cells 6-4, 6-2, and 6-5. The cells 6-4 and 6-5 are adjacent to the cell 6-2 and formed by the base stations 2-4 and 2-5, respectively. Hereinafter, the fixed routes 7-1 and 7-2 may be collectively referred to as “fixed route 7.”

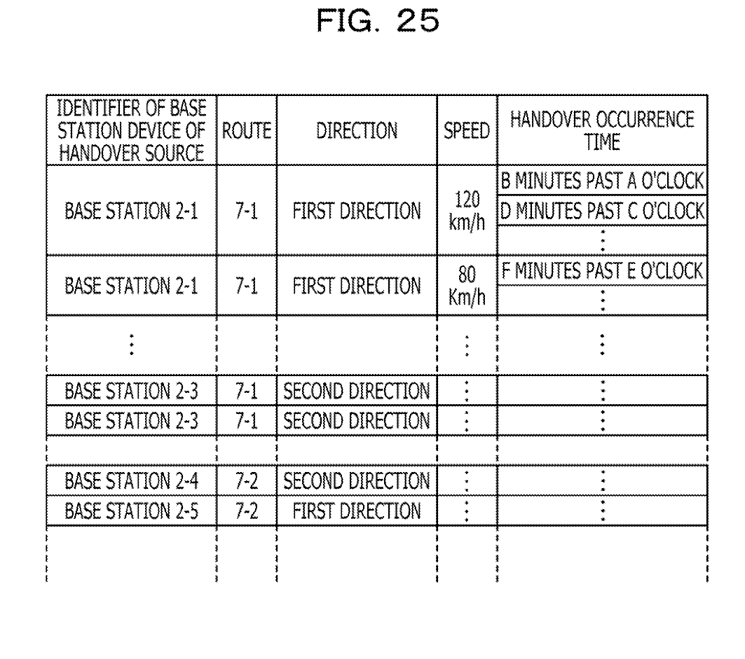

FIG. 25 is an explanatory diagram of the route information of a case where there is a plurality of fixed routes 7. The route information includes information that specifies the base station of the handover source of the UE 4 that moves on the fixed route 7 and performs the handover to the cell 6 formed by the base station 2. The route information may include the moving direction information, the speed information, the coupling time information and/or the quality information for each of the fixed routes 7.

The example illustrated in FIG. 25 illustrates an example of the route information stored in the base station 2-2 when the cell is allocated as illustrated in FIG. 24. The route information stores the identifiers of the base stations 2-1 and 2-3 that form the adjacent cells 6-1 and 6-3 through which the fixed route 7-1 pass, respectively. The route information further stores the identifiers of the base stations 2-4 and 2-5 that form the adjacent cells 6-4 and 6-5 through which the fixed route 7-2 passes. The route information includes the speed information in the base stations 2-1, 2-3 to 2-5 of each of the fixed route 7, respectively.

The UE controller 52 performs the above-described processing in each of the fixed routes 7 and may estimate the moving speed, the actual location and/or the reception quality of the UE 4. The UE controller 52 may perform the above-described processing for each of the fixed routes 7 to specify the average coupling time of the UE 4.

Another embodiment of the communication system 1 will be described. According to the embodiment of the communication system 1, the UE 4 stores the state information of the UE 4, that is, either the UE 4 is in the first state or the second state. However, the state information of the UE 4 may be stored in any component included in the communication system 1. For example, any of the base stations 2 may store the state information of the UE 4, and any of the network components of the communication network 3 may store the state information of the UE 4.

The example of the communication system in a case where the UE state recording server as the network component of the communication network 3 stores the state information of the UE 4 will be described below.

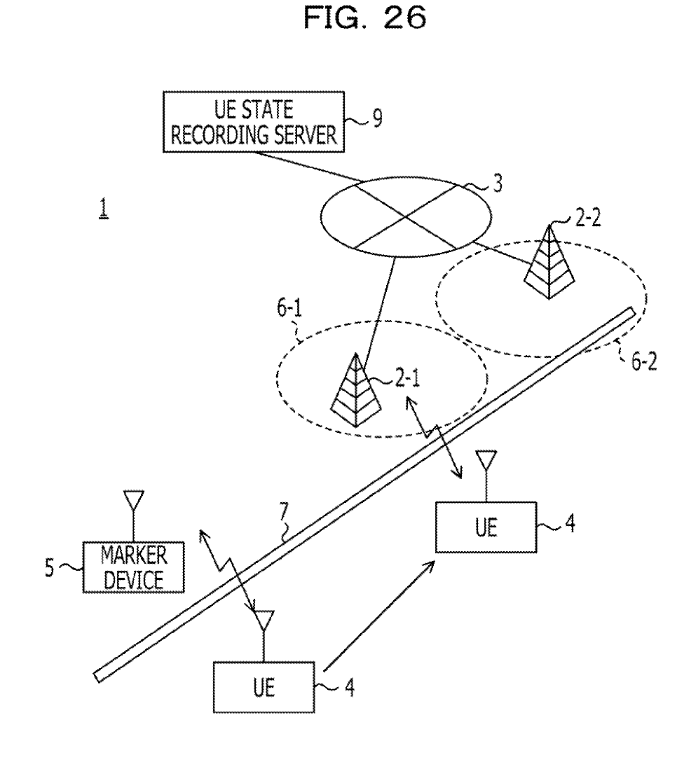

FIG. 26 is a configuration diagram of a third example of the communication system 1. The communication system 1 includes the components equivalent to the components of the communication system 1 illustrated in FIG. 1. The similar components are indicated with the similar reference numerals, so that the description of the similar function is omitted.

The communication system 1 includes a UE state recording server 9 that is coupled with the communication network 3. The UE state recording server 9 stores the state information of the UE 4 of the communication system 1. Alternatively, the UE state recording server 9 stores the UE 4 that is in the second state.

When the UE 4 passes near the marker device 5, the communication unit 30 of the UE 4 transmits the identifier (ID) of the UE 4 to the marker device 5. The marker device 5 transmits the state change request signal that requests a change of the state information of the UE 4 of the received identifier to the UE state recording server 9 through the communication network 3.

If the value of the state information of the UE 4 is in the first state, the UE state recording server 9 transfers the value to the second state. If the value of the state information of the UE 4 is in the second state, the UE state recording server 9 transfers the value to the first state.

Alternatively, the UE state recording server 9 may store that the UE 4 is in the second state or the first state depending on whether or not the UE 4 is stored. In this case, the UE state recording server 9 stores the UE 4 if the UE state recording server 9 does not store the UE 4 of which the state is desired to be changed. If the UE state recording server 9 stores the UE 4 of which the state is desired to be changed, the UE state recording server 9 deletes the storage of the UE 4.

If there is an inquiry about the state information of the UE 4 from the base station 2, the UE state recording server 9 reports the state information of the UE 4 to the base station 2. The UE state recording server 9 reports the state information of the UE 4 to the base station 2.

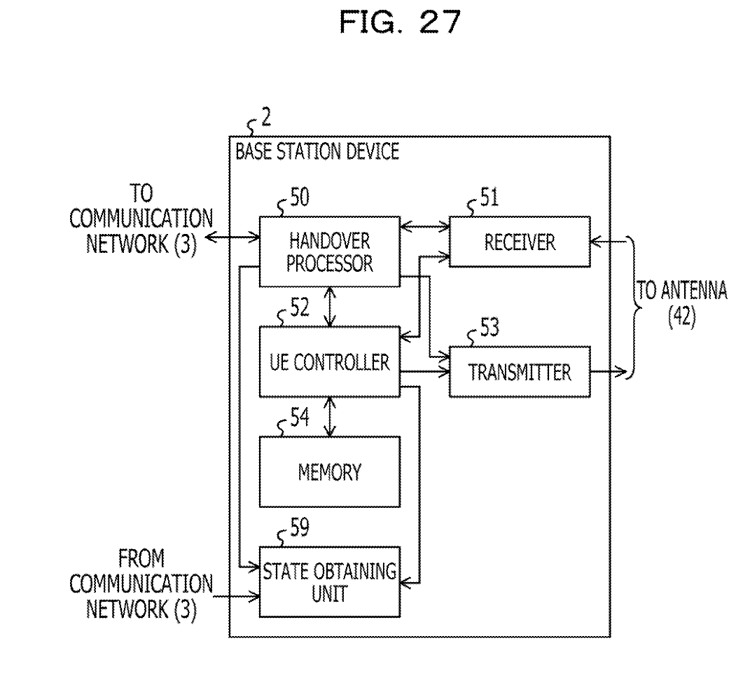

FIG. 27 is a function block of the base station used in the communication system 1 illustrated in FIG. 26. The base station 2 includes the components equivalent to the components of the embodiments described above. The similar components are indicated with the similar reference numerals, so that the description of the similar function is omitted.

The base station 2 includes a state obtaining unit 59. If the handover of the UE 4 occurs, the state obtaining unit 59 makes an inquiry to the UE state recording server 9 about the state information of the UE 4. After the state obtaining unit 59 obtains the state information from the UE state recording server 9, the UE controller 52 performs the processing equivalent to the above-described other embodiments.

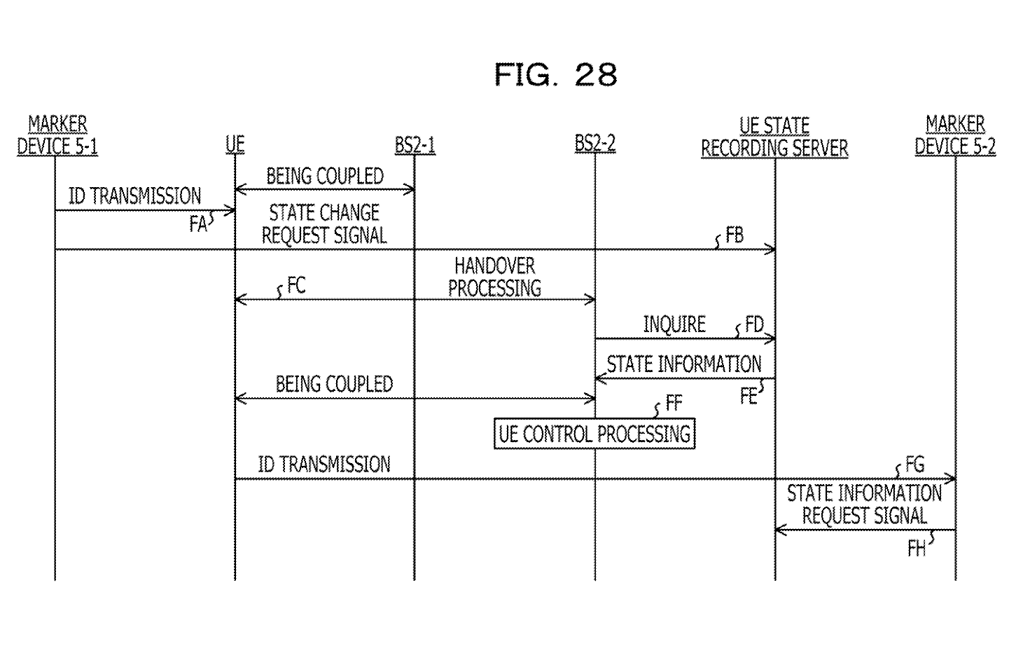

FIG. 28 is an explanatory diagram of the processing inside the communication system 1 that includes the UE state recording server 9. Hereinafter, the allocation of the base station 2, the marker device 5, the cell 6, and the fixed route 7 are equivalent to the allocation illustrated in FIG. 2. In the other embodiments, each of the following Operations FA to FI may be an operation, process or step.

The UE 4, which is positioned inside the cell 6-1, is being coupled with the base station 2-1. The UE 4 is in the first state. In Operation FA, when the UE 4 passes near the marker device 5-1, the communication unit 30 of the UE 4 transmits the identifier (ID) of the UE 4 to the marker device 5-1. In Operation FB, the marker device 5-1 transmits the state change request signal to the UE state recording server 9. The UE state recording server 9 transfers the storage of the state of the UE 4 to the second state from the first state.

After that, the UE 4 moves into the cell 6-2. In Operation FC, the handover processor 32 of the UE 4 and the handover processor 50 of the base station 2-2 perform the processing in such a way that the UE 4 performs the handover from the cell 6-1 to the cell 6-2. In Operation FD, the state obtaining unit 59 of the base station 2 makes an inquiry to the UE state recoding server 9 about the state information of the UE 4.

In Operation FE, the UE state recording server 9 reports the state information of the UE 4 to the state obtaining unit 59. In Operation FF, the UE controller 52 performs the UE control processing. The UE control processing FF may be equivalent to the UE control processing AE of the above-described other embodiment.

In Operation FG, when the UE 4 passes near the marker device 5-1, the communication unit 30 of the UE 4 transmits the identifier (ID) of the UE 4 to the marker device 5-1. In Operation FH, the marker device 5-1 transmits the state change request signal to the user state recording server 9. The user state recording server 9 transfers the storage of the state of the UE 4 to the first state from the second state.

According to the present embodiment, the state information of the UE 4 may be managed by the other components other than the UE 4. According to the present embodiment, modification of the UE 4 at a time of performing the system and the method described in the present specification may be reduced. The UE 4 does not transmit the state information to the base station 2, so that the usage of the radio resource may be reduced.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A base station comprising:
a receiver which receives a piece of state information indicating whether or not a mobile station passes through a location on a fixed route; and
a processor which performs processing which determines that the mobile station is moving on the fixed route when the received state information of the mobile station performing a handover to a cell formed by the base station indicates that the mobile station passes through a location on the fixed route.

2. The base station according to claim 1, further comprising:
a memory which stores a piece of route information which specifies a base station which forms an adjacent cell through which the fixed route passes, and
wherein the processor performs processing which determines that the mobile station is moving on the fixed route when the base station being a handover source of the mobile station is specified based on the route information.

3. The base station according to claim 1, further comprises:
a memory which stores the speed information in which a scheduled occurrence time of a handover corresponds to a scheduled speed of the mobile station that performs the handover, and
wherein the processor performs the processing which estimates the moving speed of the mobile station based on the speed information according to the handover occurrence time.

4. The base station according to claim 3, wherein the processor performs the processing which estimates the actual location of the mobile station based on an elapse time from the handover occurrence time and the estimated moving speed.

5. The base station according to claim 4, wherein the processor controls an operation of the mobile station according to the estimated actual location, and
wherein the processor comprises a transmitter which transmits control information to the mobile station.

6. The base station according to claim 4, further comprising:
a transmitter which transmits, to the mobile station, data for a service to be provided to the mobile station positioned in the estimated actual location.

7. The base station according to claim 3, wherein the memory stores the quality information that specifies scheduled reception quality in the mobile station which moves on the fixed route at each moving speed, and
wherein, based on the quality information, the processor performs the processing which estimates the reception quality between the mobile station and the base station according to the estimated moving speed or the handover occurrence time and the elapse time from the handover occurrence time.

8. The base station according to claim 7, wherein the processor generates control information which controls the operation of the mobile station according to the estimated reception quality, and
wherein the base station comprises a transmitter which transmits the control information to the mobile station.

9. The base station according to claim 3, wherein the memory stores coupling time information which specifies a coupling time in which the mobile station which moves on the fixed route at a moving speed is continuously coupled with the base station, and
wherein the processor performs the processing which determines that the mobile station is deviating from the fixed route if the actual coupling time of the mobile station is longer than the coupling time specified based on the coupling time information according to the estimated moving time or the handover occurrence time.

10. The base station according to claim 3, wherein the processor performs the processing which measures the moving speed of the mobile device, estimates the moving speed of the mobile station which performs the handover at each time based on a measured value of the speed of the mobile station, and generates speed information.

11. The base station according to claim 10, wherein the processor estimates the moving speed by averaging the measured value of the moving speed of the mobile station that performs the handover at a same time on different days.

12. The base station according to claim 7, wherein the processor performs processing which generates the quality information by measuring the moving speed of the mobile station and estimates the reception quality measured in the mobile station regarding each moving speed.

13. The base station according to claim 12, wherein the processor estimates the reception quality by averaging the reception quality which is measured several times for each moving time and each elapse time from the handover occurrence time.

14. The base station according to claim 9, wherein the processor performs the processing which measures the moving speed of the mobile station, measures the coupling time in which the mobile station moving on the fixed route is continuously coupled to the base station, estimates the coupling time for each moving speed based on the coupling time measured regarding the mobile station with each moving speed, and generates the coupling time information.

15. The base station according to claim 14, wherein the processer estimates the coupling time by averaging the coupling time which is measured several times for each moving speed.

16. A mobile station comprising:
a receiver which receives a piece of control information transmitted from a marker device provided on a location on a fixed route;
a processor which performs processing which transfers a value of a piece of state information based on receiving the control information; and
a transmitter which transmits the state information to a base station of a handover destination.

17. A communication method performed by a mobile station, the method comprising:
receiving a piece of control information, which is transmitted from a marker device provided on a location on a fixed route;
transferring a value of a piece of state information based on receiving the control information; and
transmitting the state information to a base station at a handover destination at a time of the handover.
